(19) United States
(12) Patent Application Publication
(10) Pub. No.: US 2007/0041132 A1
(43) Pub. Date: Feb. 22, 2007

(54) Thin-film magnetic head having element portion

(75) Inventors: Atsushi Tondokoro, Niigata-ken (JP); Masami Kobayashi, Niigata-ken (JP); Hideaki Kawanami, Niigata-ken (JP); Takahisa Takahashi, Niigata-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/504,373

(22) Filed: Aug. 15, 2006

(30) Foreign Application Priority Data
Aug. 22, 2005 (JP) 2005-240141

(51) Int. Cl. G11B 5/33

(52) U.S. Cl. 360/324.2; 360/126

(57) ABSTRACT

A thin-film magnetic head is provided. The thin-ffilm magnetic head includes an element portion including an antiferromagnetic layer, a pinned magnetic layer, an insulating barrier layer, and a free magnetic layer laminated on a substrate. A protective layer that protects an end face of the element portion where the end face faces a recording medium. An adhesion layer is disposed between the protective layer and the end face of the element portion, the insulating barrier layer is exposed at the end face of the element portion. The insulating barrier layer is a TiOₓ film, and nitrogen is present in at least the interface between the adhesion layer and the insulating barrier layer.

This application claims the benefit of Japanese patent Application 2005-240141 filed on Aug. 22, 2005 which is hereby incorporated by reference.

### BACKGROUND

1. Field

A thin-film magnetic head is provided.

2. Related Art

In recent years, thin-film magnetic heads (TMR heads) using tunneling magnetoresistance effects have been attracting attention as read heads that replace thin-film magnetic heads (GMR heads) using giant magnetoresistance effects. The TMR heads each include an element portion having a laminated structure containing an antiferromagnetic layer. A pinned magnetic layer whose magnetization direction is pinned by an exchange coupling magnetic field is applied between the antiferromagnetic layer and the pinned magnetic layer, an insulating barrier layer, and a free magnetic layer. A bottom electrode layer and a top electrode layer is provided, wherein the element portion is disposed between the bottom electrode layer and the top electrode layer in the lamination direction. Longitudinal bias layers apply a longitudinal magnetic field to the free magnetic layer, the longitudinal magnetic layers being disposed at both sides of the element portion. A protective layer covers the end face of the element portion facing a recording medium.

In such a TMR head, when a voltage is applied to the pinned magnetic layer and the free magnetic layer, a current (tunneling current) flows via the insulating barrier layer by the tunnel effect. The magnetization direction of the free magnetic layer is aligned perpendicular to the magnetization direction of the pinned magnetic layer when an external magnetic field is not applied. When the external magnetic field is applied, the magnetization direction of the free magnetic layer is affected by the external magnetic field to vary. When the magnetization direction of the pinned magnetic layer is antiparallel to that of the free magnetic layer, the resistance of the element portion is maximized. When the magnetization direction of the pinned magnetic layer is parallel to that of the free magnetic layer, the resistance of the element portion is minimized.

The TMR head detects a magnetic leakage field (magnetically recorded information) from a recording medium by using a change in the resistance of the element portion. In the TMR head, the rate of change in resistance (TMR ratio) is several tens of percents. Thus, it is possible to obtain significantly large read output compared with the GMR head in which the rate of change in resistance is in the range of several percents to 10-odd percents.

As disclosed in Japanese Unexamined Patent Application Publication Nos. 2005-108355 and 8-7233, in known TMR heads, generally, the pinned magnetic layer and the free magnetic layer are each composed of a ferromagnetic material, such as NiFe or FeCo. The insulating barrier layer is composed of an insulating material, such as Al₂O₃. The protective layer is composed of diamond like carbon (DLC). An adhesion layer for enhancing adhesion of the protective layer to the end face of the element portion is disposed between the DLC protective layer and the end face of the element portion. The adhesion layer is composed of silicon.

It was found that when the insulating barrier layer is composed of TiOₓ in place of Al₂O₃, TiSi is easily formed in the interface between the adhesion layer composed of silicon and the insulating barrier layer composed of titanium. A current passes through TiSi, thus reducing the output from the element portion.

### SUMMARY

A thin-film magnetic head includes an element portion containing an antiferromagnetic layer, a pinned magnetic layer, an insulating barrier layer, and a free magnetic layer laminated on a substrate. A protective layer that protects an end face of the element portion is provided with the end face facing a recording medium. An adhesion layer is disposed between the protective layer and the end face of the element portion with the insulating barrier layer being exposed at the end face of the element portion, wherein the insulating barrier layer is a TiOₓ film. Nitrogen is present in at least the interface between the adhesion layer and the insulating barrier layer.

To be specific, preferably, the end face of the element portion is a nitrided surface formed by nitriding, and the adhesion layer is composed of Si and is disposed on the nitrided surface. In an alternate embodiment, the adhesion layer is a Si-based nitride layer on the end face of the element portion and has a single-layer structure. The end face of the element portion is a nitrided surface formed by nitriding, and the adhesion layer may have a laminated structure containing a Si-based nitride layer and a Si layer laminated in that order on the nitrided surface.

Preferably, the Si-based nitride layer is composed of Si₃N₄, SiN, or SiON, and the protective layer is a diamond like carbon film.

According to the preferred embodiment, it is possible to obtain the thin-film magnetic head having high element output due to no leakage current from the insulating barrier layer even composed of TiOₓ.

In the preferred embodiments attention was focused on materials of the insulating barrier layer and the adhesion layer. Then, the preferred embodiments were accomplished by disposing an adhesion layer that stabilize bonding states of titanium atoms in the insulating barrier layer composed of TiOₓ and prevents the formation of TiSi in the interface between the insulating barrier layer and the adhesion layer to prevent the generation of a leakage current.

### DRAWINGS

FIG. 1 is a cross-sectional view that shows a thin-film magnetic head according to a first embodiment when viewed from a face that faces a recording medium;

FIG. 2 is a cross-sectional view through the center of the thin-film magnetic head;

FIG. 3 is an enlarged schematic view of an adhesion layer and the front end face of a tunneling magnetoresistive element contained in the thin-film magnetic head shown in FIG. 1;

FIG. 4 is an enlarged schematic view of an adhesion layer and the front end face of a tunneling magnetoresistive element contained in the thin-film magnetic head in accordance with a second embodiment; and

FIG. 5 an enlarged schematic view of an adhesion layer and the front end face of a tunneling magnetoresistive element contained in the thin-film magnetic head in accordance with a third embodiment.

### DESCRIPTION OF THE PREFERRED EMBODIMENTS

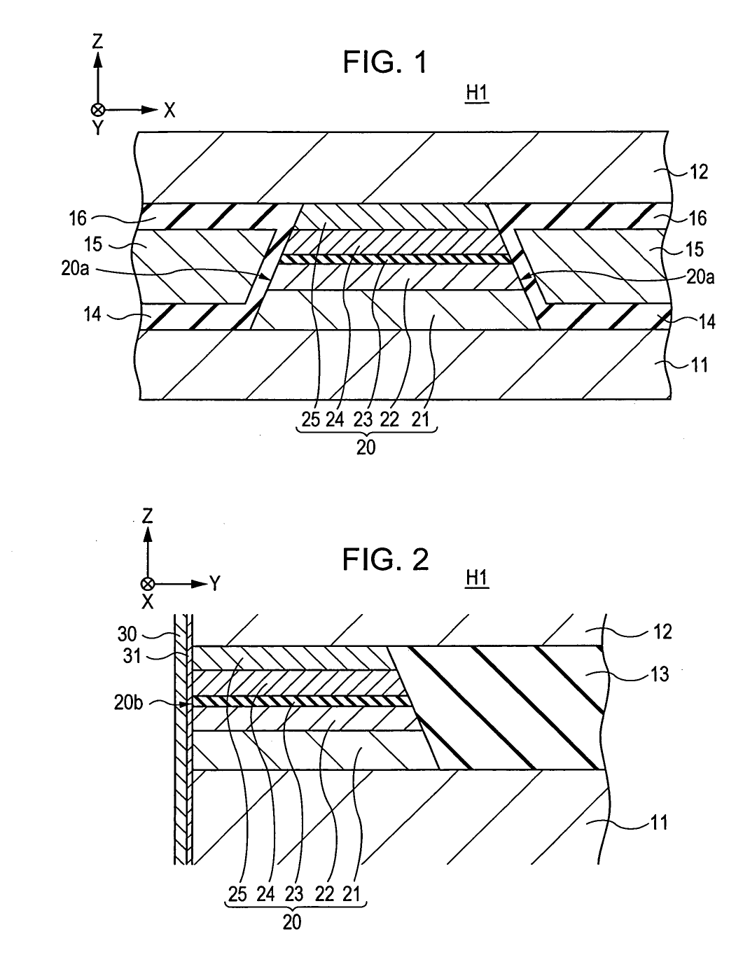

FIG. 1 is a cross-sectional view that shows the structure of a thin-film magnetic head H1 in accordance with a first embodiment when viewed from a face that faces a recording medium. FIG. 2 is a longitudinal sectional view through the center of the thin-film magnetic head H1. In the figure, the X direction indicates the track width direction. The Y direction indicates the height direction. The Z direction indicates the stacking direction of layers in a magnetoresistive element.

The thin-film magnetic head H1 is a tunneling thin-film magnetic read head (hereinafter, referred to as a “TMR head”) that detects a magnetic leakage field from the recording medium by using a tunneling effect. The thin-film magnetic head H1 includes an element portion 20, a bottom electrode layer 11, and a top electrode layer 12, the element portion 20 being disposed between the bottom electrode layer 11 and the top electrode layer 12. The element portion contains an antiferromagnetic layer 21, a pinned magnetic layer 22, an insulating barrier layer 23, a free magnetic layer 24, and a conductive layer 25 laminated in that order on the bottom electrode layer 11.

As shown in FIG. 1, both side end faces 20a are inclined such that the width of the element portion 20 in the track width direction increases with proximity to the bottom electrode layer 11. As shown in FIG. 2, an insulating layer 13 composed of Al₂O₃, SiO₂, or the like is disposed at a portion behind the element portion 20 in the height direction (Y direction shown in the figure).

The bottom electrode layer 11 and the top electrode layer 12 are each composed of a conductive material, such as Cu, W, or Cr, and each extends beyond the element portion 20 in the track width direction (X direction shown in the figure) and in the height direction (Y direction).

The antiferromagnetic layer 21 is preferably composed of an X—Mn alloy (wherein X represents at least one element selected from Pt, Pd, Ir, Rh, Ru, and Os); or an X—Mn—X′ alloy (wherein X′ represents at least one element selected from Ne, Ar, Kr, Xe, Be, B, C, N, Mg, Al, Si, Pt, V, Cr, Fe, Co, Ni, Cu, Zn, Ga, Ge, Zr, Nb, Mo, Ag, Cd, Sn, Hf, Ta, W, Re, Au, Pb, and a rare-earth elements). Each of these alloys has a disordered face-centered cubic (fcc) structure in the as-deposited state. The disordered fcc structure is converted into an ordered face-centered tetragonal (fct) structure of CuAuI type by heat treatment. As a result, a large exchange coupling magnetic field can be generated between the antiferromagnetic layer 21 and the pinned magnetic layer 22. The antiferromagnetic layer 21 in this embodiment is composed of a PtMn alloy and thus has excellent antiferromagnetic properties. For example, it is possible to generate a large exchange coupling magnetic field of above 64 kA/m between the antiferromagnetic layer 21 and the pinned magnetic layer 22. Furthermore, a blocking temperature, at which the exchange coupling magnetic field is lost, is as high as 380° C.

The pinned magnetic layer 22 is a CoFe alloy film. The magnetization direction of the pinned magnetic layer 22 is pinned in the height direction (Y direction) by, for example, the exchange coupling magnetic field generated between the antiferromagnetic layer 21 and the pinned magnetic layer 22. The insulating barrier layer 23 is a TiOₓ film having a thickness of about 0.5 nm. The free magnetic layer 24 is a CoFe alloy film. The magnetization direction of the free magnetic layer 24 is aligned in the track width direction (X direction) by a bias magnetic field from a bias layer 15. When an external magnetic field is not applied, the magnetization direction of the free magnetic layer 24 is aligned in a direction perpendicular to the magnetization direction of the pinned magnetic layer. When the external magnetic field is applied in the height direction (Y direction), the magnetization direction is affected by the external magnetic field that varies. Each of the pinned magnetic layer 22 and the free magnetic layer 24 may be a NiFe alloy film, a Co film, a CoNiFe alloy film, or the like. The conductive layer 25 is composed of a conductive material, such as Ta, and functions as an electrode together with the top electrode layer 12.

A first insulating layer 14, a bias layer 15, and a second insulating layer 16 are laminated in that order on the bottom electrode layer 11 at each side of the element portion 20, these layers being disposed between the bottom electrode layer 11 and the top electrode layer 12. The bias layers 15 are adjacent to both side end faces of the element portion 20. The bias layers 15 apply a bias magnetic field to the free magnetic layer 24 to align the magnetization direction of the free magnetic layer 24 in the track width direction (X direction) as described above. The bias layers 15 are each composed of a hard magnetic material, for example, a Co—Pt alloy or a Co—Cr—Pt alloy. An underlying bias layer (not shown in the figure) is disposed directly below the bias layers 15. The first insulating layers 14 and the second insulating layers 16 are each composed of an insulating material, for example, Al₂O₃ or SiO₂, and electrically insulate the bottom electrode layer 11 from the top electrode layer 12.

When a sense current flows in the stacking direction of the element portion 20 via the bottom electrode layer 11 and the top electrode layer 12, the magnitude of a tunneling current passing through the element portion 20 varies in response to the relationship between the magnetization directions of the pinned magnetic layer 22 and the free magnetic layer 24. For example, when the magnetization direction of the pinned magnetic layer 22 is parallel to that of the free magnetic layer 24, a conductance (G) (reciprocal of resistance) and a tunneling current are maximized. When the magnetization direction of the pinned magnetic layer 22 is antiparallel to that of the free magnetic layer 24, the conductance (G) and the tunneling current are minimized. A change in tunneling current passing through the element portion 20 is detected as a change in electric resistance. The change in electric resistance is converted into a change in voltage. In this way, the thin-film magnetic head H1 detects the magnetic leakage field from the recording medium.

As shown in FIG. 2, the front end face 20b of the element portion 20 that includes the antiferromagnetic layer 21, the pinned magnetic layer 22, the insulating barrier layer 23, the free magnetic layer 24, and the conductive layer 25 is disposed at the side of the thin-film magnetic head H1 facing the recording medium. A protective layer 30 that prevents corrosion and abrasion of the element portion 20 covers the front end face 20b. An adhesion layer 31 that improves the adhesion of the protective layer 30 to the front end face 20b is disposed. The protective layer 30 is a diamond like carbon (DLC) film.

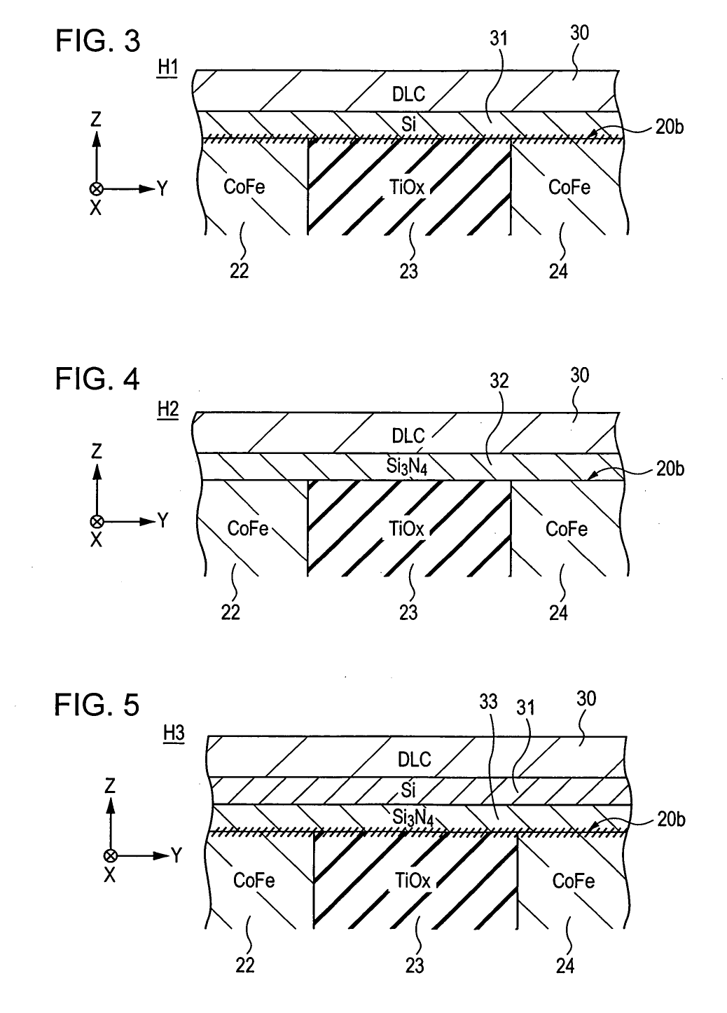

In a preferred embodiment, the adhesion layer is disposed between the front end face 20b of the element portion 20 and the protective layer 30. The adhesion layer will be described in detail below with reference to FIGS. 3 to 5.

FIG. 3 is an enlarged schematic cross-sectional view showing the adhesion layer 31 and the front end face 20b of the element portion 20 in the thin-film magnetic head Hi.

In the thin-film magnetic head H1, the front end face 20b of the element portion 20, which is the end face of the element portion 20 that faces the recording medium, is entirely nitrided to form a nitrided surface α. The adhesion layer 31 composed of silicon is laminated on the nitrided surface α. The nitrided surface α is easily formed by N₂ plasma treatment by use of a radio-frequency plasma, a microwave plasma, a reactive ion beam, or the like. The adhesion layer 31 having a small thickness is formed by sputtering, evaporation, or the like.

A number of nitrogen atoms are present in the nitrided surface α. The front end face of the insulating barrier layer 23 is covered with the nitrogen atoms to stabilize bonding states of titanium atoms in the TiOₓ film constituting the insulating barrier layer 23. Thus, the titanium atoms in the TiOₓ film have low reactivity, thereby not easily forming TiSi at the interface between the adhesion layer 31 and the insulating barrier layer 23. As a result, the probability of the generation of a leakage current decreases, thus maintaining the output from the element portion 20 at a high level.

In the first embodiment, the entire front end face 20b of the element portion 20 is nitrided to form the nitrided surface α. At least the front end face of the insulating barrier layer 23 needs to be the nitrided surface α.

FIG. 4 is an enlarged schematic cross-sectional view showing an adhesion layer 32 and the front end face 20b of the element portion 20 in a thin-film magnetic head H2 in accordance with a second embodiment.

The thin-film magnetic head H2 differs from that in the first embodiment in that the front end face 20b of the element portion 20 is not the nitrided surface, and the adhesion layer 32 composed of Si₃N₄ is disposed between the front end face 20b of the element portion 20 and the protective layer 30. When the adhesion layer 32 is a silicon-based nitrided layer, nitrogen atoms in the adhesion layer 32 stabilize the bonding states of the titanium atoms in the TiOₓ film constituting the insulating barrier layer 23, thereby not easily forming TiSi at the interface between the adhesion layer 32 and the insulating barrier layer 23. Therefore, the probability of the generation of a leakage current decreases, thereby maintaining the output from the element portion 20 at a high level. The adhesion layer 32 having a small thickness is formed by sputtering, evaporation, or the like.

The adhesion layer 32 may be composed of a silicon-based nitride, such as SiN or SiON, in place of Si₃N₄. The thin-film magnetic head H2 in accordance with the second embodiment has the same structure as that of the thin-film magnetic head H1 in accordance with the first embodiment except for the front end face 20b of the element portion 20 and the adhesion layer 32. In FIG. 4, constituent elements having the same functions as those in the first embodiment are designated using the same reference numerals as those in FIG. 1.

In the second embodiment, as shown in FIG. 4, the adhesion layer 32 entirely covers the front end face 20b of the element portion 20 and is disposed between the front end face 20b of the element portion 20 and the protective layer 30. The adhesion layer 32 needs to be disposed on at least the front end face of the insulating barrier layer 23.

FIG. 5 is an enlarged schematic cross-sectional view showing a second adhesion layer 33 and the front end face 20b of the element portion 20 of a thin-film magnetic head H3 in accordance with a third embodiment.

The thin-film magnetic head H3 differs from that in the first embodiment in that the second adhesion layer 33 composed of Si₃N₄ is disposed between the nitrided surface α (nitrided front end face 20b of the element portion 20) and the adhesion layer 31 (first adhesion layer 31). The second adhesion layer 33 further stabilizes the bonding states of the titanium atoms in the insulating barrier layer 23. Thus, the probability of the generation of a leakage current is lower than those in the first and second embodiments described above, thereby maintaining the output from the element portion 20 at a high level.

The second adhesion layer 33 having a small thickness is formed by sputtering, evaporation, or the like. The second adhesion layer 33 may be composed of a Si-based nitride, such as SiN or SiON, in place of Si₃N₄. The thin-film magnetic head H3 in accordance with the third embodiment has the same structure as that of the thin-film magnetic head H1 in the first embodiment except for the second adhesion layer 33. In FIG. 5, constituent elements having the same functions as those in the first embodiment are designated using the same reference numerals as those of the elements in FIG. 1.

In the third embodiment, the entire front end face 20b of the element portion 20 is nitrided to form the nitrided surface α. At least the front end face of the insulating barrier layer 23 needs to be the nitrided surface α. That is, the entire front end face 20b of the element portion 20 need not necessarily be the nitrided surface α. Similarly, the second adhesion layer 33 composed of Si₃N₄ needs to be disposed on at least the front end face of the insulating barrier layer 23.

As described above, in each of these embodiments, the nitrogen atoms present in the interface between the front end face 20b of the element portion 20 and the adhesion layer stabilize the bonding states of the titanium atoms in the TiO, film constituting the insulating barrier layer 23 in the element portion 20. Thus, even when the insulating barrier layer 23 is the TiOₓ film, a leakage current is not easily generated in the interface between the insulating barrier layer 23 and the adhesion layer 31, 32, or 33, thereby resulting in a high-output thin-film magnetic head.

The thin-film magnetic read head having the tunneling magnetoresistive element has been described above. The present invention can also be applied to a thin-film magnetic read/write head having a tunneling magnetoresistive element and an inductive head element.

What is claimed is:

1. A thin-film magnetic head comprising:
an element portion including an antiferromagnetic layer, a pinned magnetic layer, an insulating barrier layer, and a free magnetic layer;
an end face;
a protective layer; and
an adhesion layer disposed between the protective layer and the end face of the element portion, the insulating barrier layer being exposed at the end face of the element portion.

2. The thin-film magnetic head according to claim 1, wherein the insulating barrier layer is a TiOₓ film;

3. The thin-film magnetic head according to claim 1, wherein nitrogen is present in at least the interface between the adhesion layer and the insulating barrier layer.

4. The thin-film magnetic head according to claim 2, wherein nitrogen is present in at least the interface between the adhesion layer and the insulating barrier layer.

5. The thin-film magnetic head according to claim 1, wherein the end face of the element portion is a nitrided surface formed by nitriding; and the adhesion layer is composed of Si and is disposed on the nitrided surface.

6. The thin-film magnetic head according to claim 1, wherein the adhesion layer is a Si-based nitride layer and has a single-layer structure.

7. The thin-film magnetic head according to claim 1, wherein the end face of the element portion is a nitrided surface formed by nitriding, and the adhesion layer has a laminated structure that contains a Si-based nitride layer and a Si layer laminated on the nitrided surface.

8. The thin-film magnetic head according to claim 5, wherein the Si-based nitride layer is composed of Si₃N₄, SiN, or SiON.

9. The thin-film magnetic head according to claim 1, wherein the protective layer is a diamond like carbon film.

10. A thin-film magnetic head comprising:
an element portion including an antiferromagnetic layer, a pinned magnetic layer, an insulating barrier layer, and a free magnetic layer laminated on a substrate;
a protective layer that protects an end face of the element portion, the end face faces a recording medium; and
an adhesion layer disposed between the protective layer and the end face of the element portion, the insulating barrier layer being exposed at the end face of the element portion, wherein the insulating barrier layer is a TiOₓ film; and nitrogen is present in at least the interface between the adhesion layer and the insulating barrier layer.

11. The thin-film magnetic head according to claim 10, wherein the end face of the element portion is a nitrided surface formed by nitriding; and the adhesion layer is composed of Si and is disposed on the nitrided surface.

12. The thin-film magnetic head according to claim 10, wherein the adhesion layer is a Si-based nitride layer and has a single-layer structure.

13. The thin-film magnetic head according to claim 10, wherein the end face of the element portion is a nitrided surface formed by nitriding, and the adhesion layer has a laminated structure containing a Si-based nitride layer and a Si layer laminated in that order on the nitrided surface.

14. The thin-film magnetic head according to claim 12, wherein the Si-based nitride layer is composed of Si₃N₄, SiN, or SiON.

15. The thin-film magnetic head according to claim 10, wherein the protective layer is a diamond like carbon film.
